(19) United States
(12) Patent Application Publication
(10) Pub. No.: US 2007/0044909 A1
(43) Pub. Date: Mar. 1, 2007

(54) Method of fabricating a smart card body

(76) Inventors: Ying-Pu Chen, Chungli City (TW); Yuang-Hwa Liu, Yangmei Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/253,691

(22) Filed: Oct. 20, 2005

(30) Foreign Application Priority Data
Aug. 26, 2005 (TW) 94129359

(51) Int. Cl. B32B 37/00

(52) U.S. Cl. 156/307.3; 156/307.7

(57) ABSTRACT

A method of fabricating a smart card body is provided. A first polyurethane layer and an ink layer are sequentially formed on a first polyester substrate. A second polyurethane layer is formed on a transparent second polyester substrate. The transparent second polyester substrate is placed on the first polyester substrate, and the second polyurethane layer is positioned on the ink layer. A thermo-compression process is performed to form cross-links between the polyurethane layers and layers contacting therewith, at a temperature between 90° C. and 200° C. and pressure between 100 kg/cm² and 220 kg/cm².

### RELATED APPLICATIONS

The present application is based on, and claims priority from, Taiwan Application Serial Number 94129359, filed Aug. 26, 2005, the disclosure of which is hereby incorporated by reference herein in its entirety.

### BACKGROUND OF THE INVENTION

1. Field of Invention

The present invention relates to a method of fabricating a smart card body. More particularly, the present invention relates to a method of fabricating a smart card body by using polyester as a laminated card body.

2. Description of Related Art

The demand for well-developed Internet and the application of electronic commerce therein increases with each passing day. Thus, the application of a smart card becomes more popular.

The term “smart card” as used herein generally means a plastic card with an embedded microchip. A microchip includes a microprocessor (or electronic processing circuitry) and a memory circuit embedded therein. Thus, the smart card is capable of performing a variety of functions, including storing information, manipulation or processing information and data, providing identifying information, etc. Of course, the smart card also provides protection functions of the information that is stored in the smart card. Because of the smart card functionality, the smart card is harder to be copied than a magnetic card. Therefore, the uses of the smart card are becoming more and more diverse and widespread. For example, the smart card is applied to traffic control, medical treatments and telecommunications, or used as Medicare cards, credit cards, ID cards and the like. Therefore, the smart card will likely play an important role in the future.

However, in addition to producing a highly secure smart card, the flexibility, durability, and surface design of the card body are also very important. Generally, different materials are used in the typical laminated card body, such as polyvinyl chloride (PVC), polyethylene terephthalate (PET) and the like, depending on which printing process is performed. In recent years, rigid materials like PET have been used as the substrates of the laminated card body.

Overprint varnish (OPV) is used as an adhesive between a substrate and an ink layer to form a laminated card body in the conventional methods of fabricating a smart card body. However, the problem of the conventional methods is that the saturation of the printing ink, i.e. the amount of the printing ink used in the card body, cannot be more than 40%. If the saturation of the printing ink were above 40%, the adhesion strength between the substrate and the ink layer would be too weak to maintain adhesion, and the ink layer would thus easily peel from the substrate. Therefore, the area of the card body, which can be overlaid by the printing ink, is limited. Moreover, it is also hard to fabricate a beautiful and functional laminated card body.

### SUMMARY

In one aspect, this present invention provides a method of fabricating a smart card body that is applicable to enhance the adhesion between an ink layer and a substrate while the saturation of the printing ink is over 40%.

In another aspect, this present invention provides a method of fabricating a smart card body that provides a good adhesion between an ink layer and a substrate, such that a beautiful laminated card body is obtained.

In accordance with the foregoing and other aspects of the present invention, the present invention provides a method of fabricating smart card bodies. Polyurethane is used as an adhesive between an ink layer and a substrate. According to one embodiment of the present invention, a first polyurethane layer is formed over a first polyester substrate. A material of the first polyester layer mentioned above is, for example, PET. The first polyurethane layer is dried. Then, the appropriate printing ink is selected according to the demands, and a printing process is performed to form a first ink layer over the first polyurethane layer. Thus, a first core sheet is formed, which is composed of the first polyester substrate, the first polyurethane layer and the first ink layer. Preferably, the first ink layer mentioned above is an anhydrous ink layer, and the amount of the printing ink used to cover the laminated card body, i.e. the saturation of the ink layer, is between 40% and 100%.

After that, a second polyurethane layer is formed over a transparent second polyester substrate. The second polyurethane layer is dried. Then, a transparent first sheath sheet is formed, which is composed of the second polyurethane layer and the second polyester substrate. Next, the transparent first sheath sheet is positioned over the first core sheet, and the second polyurethane layer of the first sheath sheet is located directly over the first ink layer of the first core sheet. After that, a thermo-compression process is performed under an appropriate temperature and pressure to form a front card. The temperature of the foregoing thermo-compression process is preferably between 90° C. and 200° C., and more preferably between about 120° C. and about 125° C. The pressure of the thermo-compression process is preferably between 100 kg/cm² and 220 kg/cm², and more preferably about 200 kg/cm².

The thermo-compression process is performed to form cross-links between the polyurethane layers and a layer contacting therewith, so that the adhesion strength between each polyester substrate and ink layer is enhanced.

Alternatively, a complete smart card body can be produced according to the demands. First, a back card is produced, which is composed of a second core sheet and a second sheath sheet. The second core sheet is composed of a third polyester substrate, a third polyurethane layer and a second ink layer. And the sheath sheet is composed of a fourth polyurethane layer and a fourth polyester substrate. An antenna pattern is selected to be printed on the front side or back side of the third polyester substrate. A polyurethane layer is formed over the third polyester substrate. Then, the front card is positioned over the back card, in which the polyurethane layer is located between the first polyester substrate of the front card and the third polyester substrate of the back card. After that, the thermo-compression process is performed to form a smart card body.

Thus, the smart card body fabricated according to the method described above has good tensile strength. The present invention uses polyurethane as an adhesive, and a thermo-compression process is performed under a preferable temperature and pressure, so that the ink layers can be adhered firmly to each polyester substrate to meet the standard tensile strength. Furthermore, while the saturation of the printing ink is over 40%, this present invention is applied to enhance tensile strength between an ink layer and polyester substrate, and a beautiful laminated card is thus obtained.

It is to be understood that both the foregoing general description and the following detailed description are by examples and are intended to provide further explanation of the invention as claimed.

### BRIEF DESCRIPTION OF THE DRAWINGS

The invention can be more fully understood by reading the following detailed description of the preferably embodiment, with reference made to the accompanying drawings as follows:

FIG. 1 is a schematic diagram showing a core sheet of a laminated card body according to one embodiment of the present invention.

FIG. 2 is a schematic diagram showing a sheath sheet of a laminated card body according to one embodiment of the present invention.

FIG. 3 is a schematic diagram showing a front card according to one embodiment of the present invention.

FIG. 4 is a schematic diagram showing a back card according to one embodiment of the present invention.

FIG. 5 is a schematic diagram showing a laminated card body according to one embodiment of the present invention.

### DESCRIPTION OF THE PREFERABLY EMBODIMENTS

The present invention provides a method of fabricating a smart card body in which polyurethane is used as an adhesive between an ink layer and a polyester substrate to enhance the tensile strength between the ink layer and the polyester substrate.

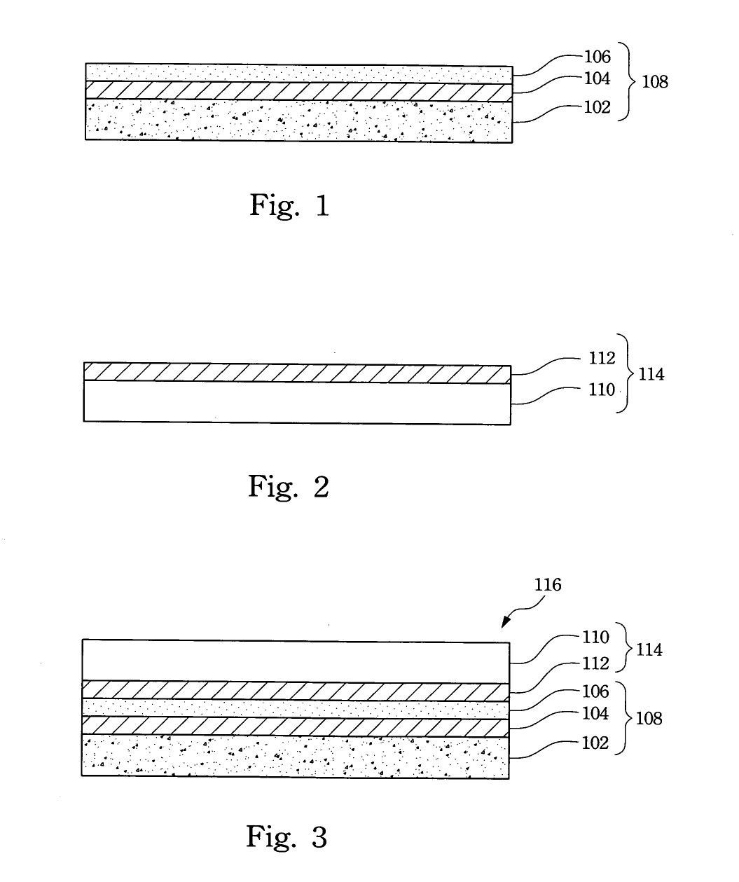

FIG. 1 is a schematic diagram showing a core sheet of a laminated card body according to one embodiment of the present invention. In FIG. 1, polyurethane is coated on a first polyester substrate 102 to form a first polyurethane layer 104. The first polyurethane layer 104 is dried to adhere to the first polyester substrate 102. The first polyester substrate 102 is preferably a PET substrate.

After that, a printing process is performed. The first polyester substrate 102 with the first polyurethane layer 104 is placed in a lithographic printing press. After selecting ink according to the demands, a printing process is performed to form a first ink layer 106 over the first polyurethane layer 104. Thus, a first core sheet 108 is formed, which is composed of the first polyester substrate 102, the first polyurethane layer 104 and the first ink layer 106. Preferably, the first ink layer 106 mentioned above is an anhydrous ink layer, and the amount of the printing ink used to cover the laminated card body, i.e. the saturation of the ink layer 106, can be over 40%.

FIG. 2 is a schematic diagram showing a sheath sheet of a laminated card body according to one embodiment of the present invention. After a transparent second polyester substrate 110 is placed in a screen printing press, the polyurethane is coated on the second polyester substrate 110 to form a second polyurethane layer 112. The second polyurethane layer 112 is dried after coating. Thus, a transparent first sheath sheet 114 is formed, which is composed of the second polyurethane layer 112 and the second polyester substrate 110.

Next, a thermo-compression process is performed. FIG. 3 is a schematic diagram showing a front card according to one embodiment of the present invention. First, the first sheath sheet 114 is positioned over the first core sheet 108, and the second polyurethane layer 112 of the first sheath sheet 114 is located directly over the first ink layer 106 of the first core sheet 108. A thermo-compression process is performed under an appropriate temperature and pressure to form a front card 116. The temperature of the foregoing thermo-compression process is preferably between 90° C. and 200° C., and more preferably between about 120° C. and about 125° C. The pressure of the thermo-compression process is preferably between 100 kg/cm² and 220 kg/cm², and more preferably about 200 kg/cm².

The thermo-compression process is performed to form cross-links between the polyurethane layer and a layer contacting therewith, such as between the first polyester substrate 102 and the first ink layer 106, and between the first ink layer 106 and the second polyester substrate 110, so that the adhesion strength between each polyester substrate and ink layer is enhanced.

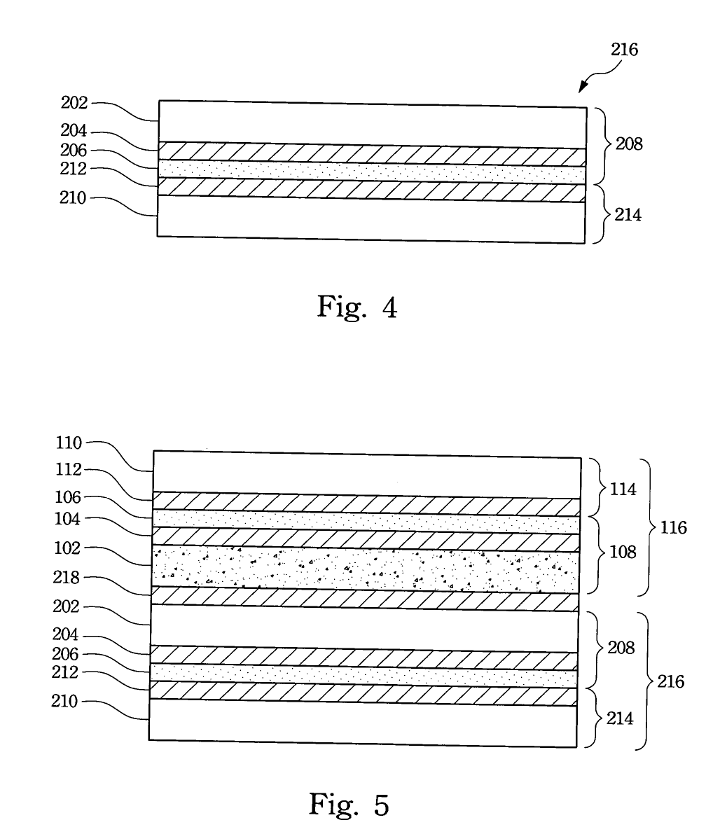

Alternatively, a complete smart card body can be produced according to the demands. FIG. 4 is a schematic diagram showing a back card according to one embodiment of the present invention. First, a back card 216 is produced, which is composed of a second core sheet 208 and a second sheath sheet 214. The second core sheet 208 is composed of a third polyester substrate 202, a third polyurethane layer 204 and a second ink layer 206. A sheath sheet 214 is composed of a fourth polyurethane layer 212 and a fourth polyester substrate 210. An antenna pattern is selected to be printed on the front side or back side of the third polyester substrate 202. The method of fabricating the second core sheet 208 is the same as that of the first core sheet 108, and the method of fabricating the second sheath sheet 214 is the same as that of the first sheath sheet 114.

FIG. 5 is a schematic diagram showing a laminated card body according to one embodiment of the present invention. A polyurethane layer 218 is formed over the third polyester substrate 202. Then, the front card 116 is positioned over the back card 216 to form a laminated structure, in which the polyurethane layer 218 is located between the first polyester substrate 102 of the front card 116 and the third polyester substrate 202 of the back card 216. After that, the aforementioned laminated structure is placed in a thermo-compression machine to perform a thermo-compression process to form a laminated card body. The temperature and pressure of the foregoing thermo-compression are preferably the same as that of the front card 116.

A tensile strength test is performed. The test method of the present invention is according to ISO 10,373; and the standard tensile strength of a smart card body is 3.5 N/cm². A tensile strength machine is used for the test. After a test material is cut into a specific shape, the test material is placed in a tensile strength machine. Then, the test material is stretched with predetermined speed and force until the test material breaks. A tensile strength of the material is hence determined. The tensile strength of the smart card body fabricated by the method of one embodiment of the present invention meets the requirement of the standard tensile strength.

The result of the tensile strength mentioned above shows that the smart card body fabricated according to the method described above has good tensile strength. The present invention uses polyurethane as an adhesive, and a thermo-compression process is performed at a preferred temperature and pressure, so that the ink layers can be adhered firmly to each polyester substrate to meet the standard tensile strength. Besides, even when the saturation of the printing ink is over 40%, this present invention is applied to enhance the tensile strength between the ink layer and the polyester substrate, and a beautiful laminated card is thus obtained.

It will be apparent to those skilled in the art that various modifications and variations can be made to the structure of the present invention without departing from the scope or spirit of the invention. In view of the foregoing, it is intended that the present invention includes modifications and variations of this invention provided they fall within the scope of the following claims and their equivalents.

What is claimed is:

1. A method of fabricating a smart card, the method comprising:
forming a first polyurethane layer on a first polyester substrate;
forming a first ink layer on the first polyurethane layer to compose a first core sheet;
forming a second polyurethane layer on a transparent second polyester substrate to compose a first sheath sheet;
positioning the first sheath sheet over the first core sheet to form a front card, wherein the second polyurethane layer of the first sheath sheet is on the first ink layer of the first core sheet;
forming a third polyurethane layer on a third polyester substrate;
forming a second ink layer on the third polyurethane layer to compose a second core sheet;
forming a fourth polyurethane layer on a transparent fourth polyester substrate to compose a second sheath sheet;
positioning the second sheath sheet over the second core sheet to form a back card, wherein the fourth polyurethane layer of the second sheath sheet is connected with the second ink layer of the second core sheet;
forming a polyurethane layer on the third polyester substrate;
positioning the front card over the back card, wherein the polyurethane layer is located between the first polyester substrate and the third polyester substrate; and
performing a thermo-compression process at a temperature between 90° C. and 200° C. and a pressure between 100 kg/cm² and 220 kg/cm² to form cross-links across interfaces associated with the first, the second, the third and the fourth polyurethane layers.

2. The method of claim 1, wherein the temperature of the thermo-compression process is between about 120° C. and about 125° C.

3. The method of claim 1, wherein the pressure of the thermo-compression process is about 200 kg/cm².

4. The method of claim 1, further comprising printing an antenna pattern on the third polyester substrate.

5. The method of claim 1, wherein a material of the first, the transparent second, the third and the transparent fourth polyester substrate comprises polyethylene terephthalate.

6. The method of the claim 1, wherein the first ink layer and the second ink layer are anhydrous ink layers.

7. The method of the claim 6, wherein saturations of the first ink layer and the second ink layer are between 40% and 100%.

8. A method of making a laminated card being capable of having ink saturation over 40%, the method comprising:
forming a first polyurethane layer on a first polyester substrate;
forming an ink layer on the first polyurethane layer to compose a first core sheet;
forming a second polyurethane layer on a transparent second polyester substrate to compose a first sheath sheet;
positioning the first sheath sheet over the first core sheet, wherein the second polyurethane layer is on the first ink layer; and
performing a thermo-compression process at a temperature between 90° C. and 200° C. and a pressure between 100 kg/cm² and 220 kg/cm² to form cross-links across interfaces associated with the first and the second polyurethane layer.

9. The method of claim 8, wherein the temperature of the thermo-compression process is between about 120° C. and about 125° C.

10. The method of claim 8, wherein the pressure of the thermo-compression process is about 200 kg/cm².

11. The method of the claim 8, wherein the ink layer is an anhydrous ink layer.

12. The method of the claim 11, wherein saturation of the ink layer is between 40% and 100%.

13. The method of claim 8, wherein the material of the first and the transparent second polyester substrate comprises polyethylene terephthalate.

14. A method of fabricating a plastic card, the method comprising:
forming a first polyurethane layer on a first polyester substrate;
forming an ink layer on the first polyurethane layer;
forming a second polyurethane layer on a second polyester substrate;
contacting the second polyurethane layer with the ink layer; and
performing a thermo-compression process at a temperature between 90° C. and 200° C. and a pressure between 100 kg/cm² and 220 kg/cm² to form cross-links across interfaces associated with the first and the second polyurethane layer.

15. The method of claim 14, wherein the temperature of the thermo-compression process is between about 120° C. and about 125° C.

16. The method of claim 14, wherein the pressure of the thermo-compression process is about 200 kg/cm².

17. The method of claim 14, wherein the material of the first and the second polyester substrate comprises polyethylene terephthalate.
